(19) United States
(12) Patent Application Publication
(10) Pub. No.: US 2021/0373668 A1
(43) Pub. Date: Dec. 2, 2021

(54) GLOVES WITH SELF-CONTAINED HAPTIC FEEDBACK SYSTEMS

(71) Applicant: Hewlett-Packard Development Company, L.P., Spring, TX (US)

(72) Inventors: Busarin Chumnong, Houston, TX (US); Dimitre Mehandjiysky, Spring, TX (US)

(73) Assignee: Hewlett-Packard Development Company, L.P., Spring, TX (US)

(21) Appl. No.: 17/042,495

(22) PCT Filed: May 21, 2018
(86) PCT No.: PCT/US2018/033649

§ 371 Date: Sep. 28, 2020

(51) Int. Cl. G06F 3/01

(52) U.S. Cl. CPC G06F 3/016; G06F 3/014

(57) ABSTRACT

In one example in accordance with the present disclosure, a computing input device is described. The computing input device includes a glove to be worn by a user. The computing input device also includes a self-contained haptic feedback system disposed on the glove. The self-contained haptic feedback system includes a number of sensors disposed in the glove to collect information from an inserted hand. An inflatable haptic feedback device of the system is positioned over a palm region of the glove. A control system of the self-contained haptic feedback system provides fluidic and electronic control over the inflatable haptic feedback device.

### BACKGROUND

Enhanced reality systems allow a user to become immersed in an enhanced reality environment wherein they can interact with the enhanced reality environment. For example, a head-mounted display, using stereoscopic display devices, allows a user to see, and become immersed in, any desired virtual scene. Such enhanced reality applications also provide visual stimuli, auditory stimuli, and can track user movement to create a rich immersive experience.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing input device with a self-contained haptic feedback system, according to an example of the principles described herein,

FIG. 2 is a block diagram of a computing input device with a self-contained haptic feedback system, according to an example of the principles described herein.

FIG. 3 is a palm view of a glove with a self-contained haptic feedback system, according to an example of the principles described herein.

FIG. 4 is a backhand view of a glove with a self-contained haptic feedback system, according to an example of the principles described herein.

FIG. 5 is a flowchart showing a method of controlling a glove with a self-contained haptic feedback system, according to an example of the principles described herein.

FIG. 6 is a flowchart showing a method of controlling a glove with a self-contained haptic feedback system, according to an example of the principles described herein.

FIG. 7 is a palm view of a glove with a self-contained haptic feedback system, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Enhanced reality systems allow a user to become immersed in an enhanced reality environment wherein they can interact with the enhanced environment. For example, a head-mounted display, using stereoscopic display devices, allows a user to see, and become immersed in, any desired virtual scene. Such virtual reality applications also provide visual stimuli, auditory stimuli, and can track user movement to create a rich immersive experience.

Enhanced reality systems include virtual reality (VR) systems, augmented reality (AR) systems, and mixed reality (MR) systems. Such enhanced reality systems can include enhanced reality headsets to generate realistic images, sounds, and other human discernable sensations that simulate a user's physical presence in a virtual environment presented at the headset. A VR system includes physical spaces and/or multi-projected environments. AR systems may include those systems and devices that implement live direct and/or indirect displays of a physical, real-world environment whose elements are augmented by computer-generated sensory input such as sound, video, graphics and/or GPS data. MR systems merge real and virtual worlds to produce new environments and visualizations where physical and digital objects co-exist and interact in real time. For simplicity, VR systems, AR systems, and MR systems are referred to herein as enhanced reality systems.

While such enhanced reality systems have undoubtedly provided a valuable tool in many industries as well as a source of diversion for users, some characteristics impede their more complete implementation. For example, when interacting with the physical world, tactile or haptic feedback provides valuable sensory information to an individual. For example, as a user grasps a tool or other object in their hand, the mass of the tool indicates to the user information relating to the object they are grasping. Information such as its weight, density, and firmness. This information can provide a user with valuable sensory feedback, such as whether they have gripped the object sufficiently to pick it up. The sensory feedback can provide additional information on which a user can rely to process a situation. The replication of this sensory information in an enhanced reality environment is difficult to replicate.

Moreover, such devices, when power sources or fluid sources are located off the glove, may be cumbersome and may restrict movement. Both of these effects may impair the usability of the VR/AR/MR system.

Accordingly, the present specification describes a system that replicates, in the enhanced reality environment, the sensory information that a user receives when interacting with objects in the physical environment.

Specifically, the present specification describes a computing input device. The computing input device includes a glove to be worn by a user. The computing input device also includes a self-contained haptic feedback system disposed on the glove. The self-contained haptic feedback system includes a number of sensors disposed in the glove to collect information from an inserted hand. An inflatable haptic feedback device is positioned over a palm region of the glove and a control system provides fluidic and electronic control over the inflatable haptic feedback device.

The present specification also describes a method. According to the method, interaction data is received from a computing input device. The interaction data indicates interaction of a virtual hand of a user within an enhanced reality environment. The interaction data is converted into control data which activates an inflatable haptic feedback device. The inflatable haptic feedback device is located in a palm region of a glove. A pump that is also disposed on the glove is then actuated to inflate the inflatable haptic feedback device based on the control data.

The present specification also describes another example of a computing input device. In this example, the computing input device includes a glove to be worn by a user and a self-contained haptic feedback system disposed on the glove. The self-contained haptic feedback system includes the number of sensors. A first set of sensors generates position data. The control system of the self-contained haptic feedback system forms a representation of the inserted hand in the enhanced reality environment based on the position data. The computing input device also includes the inflatable haptic feedback device. In this example, the control system includes a pump disposed on the glove to inflate and deflate the inflatable haptic feedback device based on received control data. The self-contained haptic feedback system also includes a flexible battery disposed on a dorsal region of the glove to power the number of sensors, the inflatable haptic feedback device, and the pump. The computing input device also includes a number of additional haptic feedback devices disposed on the glove.

In summary, using such a computing input device 1) digitizes a user's hand thus making it visible in the enhanced reality environment; 2) provides a user with a sensation of physically holding an object represented in the enhanced reality environment; 3) creates a more immersive enhanced reality environment; and 4) is self-contained to enhanced user mobility. However, the devices disclosed herein may address other matters and deficiencies in a number of technical areas.

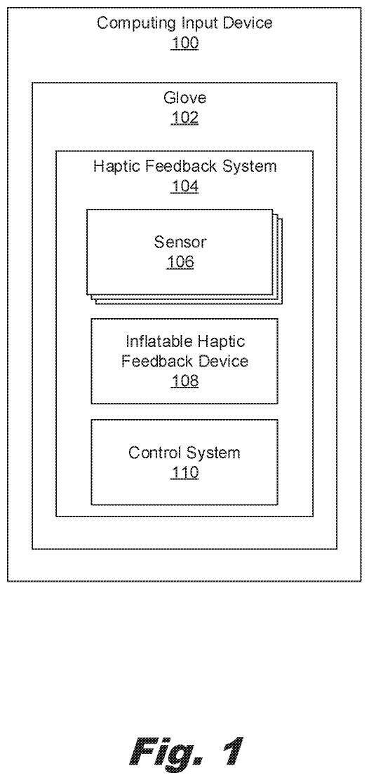

Turning now to the figures, FIG. 1 is a block diagram of a computing input device (100) with a self-contained haptic feedback system (100), according to an example of the principles described herein. Specifically, the computing input device (100) includes a glove (102) that is to be worn by a user. The glove (102) may be made of any fabric including neoprene, polyester, nylon, and cotton, among others. The glove (102) may be sized to fit a particular user and may either provide a tight fit or a loose fit.

Disposed on the glove (102) is a haptic feedback system (104) that is self-contained. That is, the haptic feedback system (104) may reside entirely on the glove (102) with each component that makes up the haptic feedback system (104) disposed on the glove (102). In this fashion, the glove (102) may be a standalone unit that does not rely on any external mechanical components to provide the haptic feedback. For example, as will be described below a control system (110) or a battery for the haptic feedback system (104) are contained on the glove (102).

A haptic feedback system (104) provides a tactile, or touch sensation to the user. In some examples this feedback may be related to the enhanced reality environment in which a user is immersed. For example, a user may be immersed in an enhanced reality environment and in that environment the user may grab a tool. The haptic feedback system (104) of the present specification may provide haptic feedback to replicate the handle of the tool such that the user not only sees him/herself picking up the tool, but feels the tool in their hand thus enhancing the immersive experience.

To create such an effect, the haptic feedback system (104) includes various components. For example, the haptic feedback system (104) includes a number of sensors (106) disposed in, or on, the glove (102) to collect information from an inserted hand. In some examples, the sensors (106) may be motion sensors (106). In this example, the sensors can detect the position and/or motion of a hand within the glove (102) such that a reproduction of the position and/or movement is generated in the enhanced reality environment. The sensors (106) may also include heat sensors and/or pressure sensors to deliver additional information related to the hand. Such data can be used to 1) facilitate the generation of the digital representation of the hand, 2) facilitate immersion into the enhanced reality environment, and 3) select the form and/or characteristics of the haptic feedback.

The self-contained haptic feedback system (104) also includes an inflatable haptic feedback device (108). The inflatable haptic feedback device (108) may be positioned over a palm region of the glove (102). The inflatable haptic feedback device (108) can be inflated and deflated based on a corresponding action in the enhanced reality environment. For example, the inflatable haptic feedback device (108) may be a bladder that fills with a fluid such as air or water to replicate a virtual object in an enhanced reality environment.

As a specific example, a virtual hand may grip an object or may be placed against a representation of a surface such as a wall. In this example, the inflatable haptic feedback device (108) can be inflated to represent the physical contact with the object or placement of the hand against a physical wall. The inflatable haptic feedback device (108) may be formed of a variety of materials including urethane, flexible polyvinyl chloride (PVC), and nylon, among others.

In some examples, the inflatable haptic feedback device (108) has a shape to match the ergonomics of the hand, and more particularly to match the particular ergonomics of a particular user's hand. By using an inflatable haptic feedback device (108) that matches the ergonomics of the hand, a natural touch sensation can be passed to the user.

In some examples, the inflatable haptic feedback device (108) may be covered by a material that stretches based on the inflation and deflation of the inflatable haptic feedback device (108). Such a stretchable and flexible material allows the inflatable haptic feedback device (108) to inflate and deflate while providing protection against mechanical damage, such as puncture, of the inflatable haptic feedback device (108).

The haptic feedback system (104) also includes a control system (110) to provide a fluidic and electronic control over the inflatable haptic feedback device (108). That is, fluid such as air or water may be pumped into the inflatable haptic feedback device (108) during inflation. The fluid may be drawn from the inflatable haptic feedback device (108) during deflation. Accordingly, the control system (110) may include the pathways as well as the pump to facilitate the fluid transportation.

The control system (110) may also provide electronic control. That is, the control system (110) may manage the power delivery to a pump that moves the fluid. As described above, the haptic feedback system (104) may be self-contained on the glove (102). Accordingly, the control system (110), like the other components, may be disposed on the glove (102). In some examples, the control system (110) may be on a same side of the glove (102) as the inflatable haptic feedback device (108) and in other examples may be on an opposite side of the glove (102) as the inflatable haptic feedback device (108).

As described herein, the computing input device (100) that includes a glove (102) with a self-contained inflatable haptic feedback system (104) allows for a more immersive enhanced reality experience by generating haptic feedback that replicates physical contact. Such a system may be implemented in a variety of scenarios including gaming and business-related applications such as industrial design.

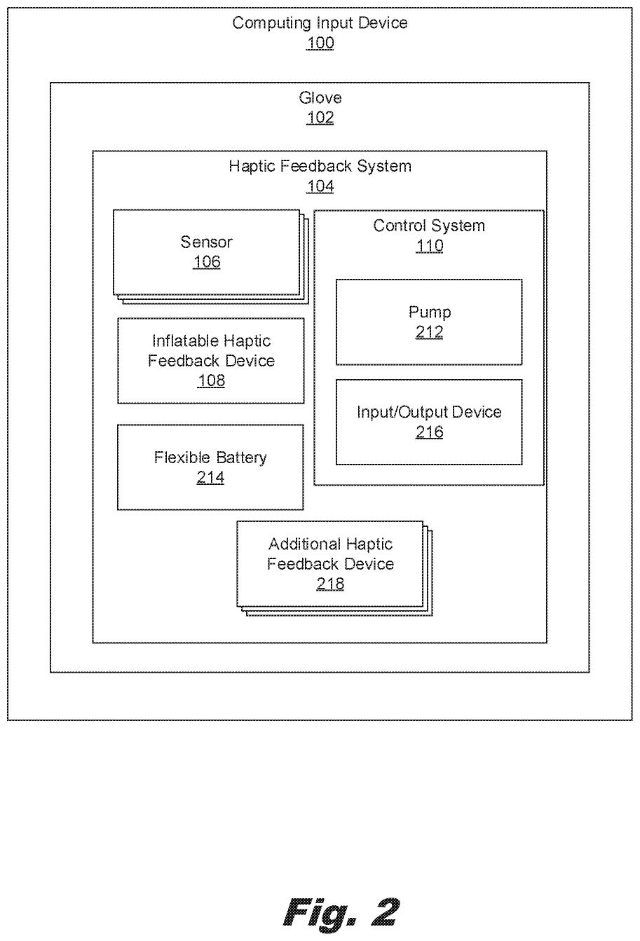

FIG. 2 is a block diagram of a computing input device (100) with a self-contained haptic feedback system (104), according to an example of the principles described herein. In the example depicted in FIG. 2, the self-contained haptic feedback system (104) includes the array of sensors (106), inflatable haptic feedback device (108), and control system (110) as described earlier. In this example the self-contained haptic feedback system (104) includes various other components.

For example, the self-contained haptic feedback system (104), and specifically the control system (110), may include a pump (212). Like other components of the self-contained haptic feedback system (104), the pump (212) may be disposed entirely on the glove (102). The pump (212) operates to inflate and deflate the inflatable haptic feedback device (108). Inflating and deflating the inflatable haptic feedback device (108) may be based on control data from the control system (110). For example, within the enhanced reality environment a user may grasp a virtual object or otherwise interact with a virtual object. The control system (110) may receive information defining such contact. The control system (110) then converts this interaction data into pump (212) control data to inflate the inflatable haptic feedback device (108) to a certain degree to replicate that interaction.

The self-contained haptic feedback system (104) may also include a flexible battery (214). The flexible battery (214) provides operating power to the components of the self-contained haptic feedback system (104). In this example, the flexible battery (214) may be formed of a thin material that flexes, but does not plastically deform. That is, for a given amount of force the flexible battery (214) can conform to a shape. As will be described below, the flexible battery (214) may be positioned within the walls of the glove (102) in a location that corresponds to a neutral surface of the hand. In this context, neutral refers to a portion of the hand that does not move or flex much. Examples of such locations includes that region just below the wrist joint or the dorsal portion of the wrist.

The flexible battery (214) may be charged via a number of methods. In one example, the flexible battery (214) is charged via a tethering cable. In this example, the flexible battery (214) is coupled to an electrical outlet and charged. In another example, the flexible battery (214) is charged wirelessly. That is, the flexible battery (214) may include components that when proximate to a charging station, replenish the flexible battery (214). Examples of wireless charging methods include using wireless charging coils within the glove (102) that are placed in close proximity contact with coils in a charging station. The proximity of the coils triggers transfer of electrical power wirelessly. In this and other examples, the charging components of the glove (102) and the charging station do not have to be in direct contact, but can be within a specified range. In these examples, the wireless power can “jump” and charge the flexible battery (214).

Another example of wireless charging is optical wireless charging. In this example, the glove (102) includes a small window placed on top of the flexible battery (214). When placed in proximity to a wireless power emitter, the emitter distributes a focused electrical power stream through the window, thus charging the flexible battery (214). Other examples of charging the flexible battery (214) include via thermoelectric harnessing where a small thermoelectric generator harnesses electrical power from the skin while the user is wearing the glove (102). This energy is used to power the haptic feedback system (104) or to charge the flexible battery (214). In another example, the flexible battery (214) may be photovoltaic, meaning ambient light charges the flexible battery (214) or otherwise provides power to the components of the haptic feedback system (104).

By including the flexible battery (214) on the glove (102), the glove (102) operates as a standalone feedback device that both provides haptic feedback and powers the components that provide the haptic feedback. Doing so is advantageous as a user need not be tethered to a power source during use of the haptic feedback system (104). Such a tethered power system can impede the immersive nature of the experience. Moreover, by not having the haptic feedback system (104) on the glove (102) draw power from somewhere else on the body, for example, a battery disposed on an arm region, full mobility is possible.

In this example the haptic feedback system (104), and specifically the control system (110), also includes an input/output device (216) that allows the haptic feedback system (104) to communicate with other enhanced reality interaction components. For example, the self-contained haptic feedback system (104) may interact with other systems, such as other articles of clothing that similarly have sensors and feedback devices for immersing a user in an enhanced reality environment. As another example, the haptic feedback system (104) may interact with a computing input device that generates the enhanced reality environment, an application that uses the enhanced reality environment, and other computing input devices such as smartphones. The input/output device (216) facilitates such communication. In some examples, the input/output device (216) may include an antenna, such as a short distance antenna, to facilitate this communication. Other examples of devices that communicate with the self-contained haptic feedback system (104) on the glove (102) include an enhanced reality display device in the form of wearable goggles, an enhanced reality auditory device, and enhanced reality controllers.

In this example, the self-contained haptic feedback system (104) includes additional haptic feedback devices (218) disposed at different places on the glove (102). Such additional haptic feedback devices (218) provide feedback that can further enhance the experience. For example, heat feedback devices may generate a heat sensation when a user in the enhanced environment interacts with a hot object. In another example a user may receive alerts via vibration feedback devices. Another example of a feedback device is a pressure feedback device. While specific reference is made to particular feedback devices, any number of feedback devices may be implemented on the self-contained haptic feedback system (104) found on the glove (102).

Such additional haptic feedback devices (218) may be disposed at various locations on the glove (102). For example, additional haptic feedback devices (218) may be disposed at different points along the finger regions of the glove (102) to provide sensory feedback at those areas which are sensitive to touch. Such additional haptic feedback devices (218) provide additional opportunities for the user to feel completely entrenched in the enhanced reality environment.

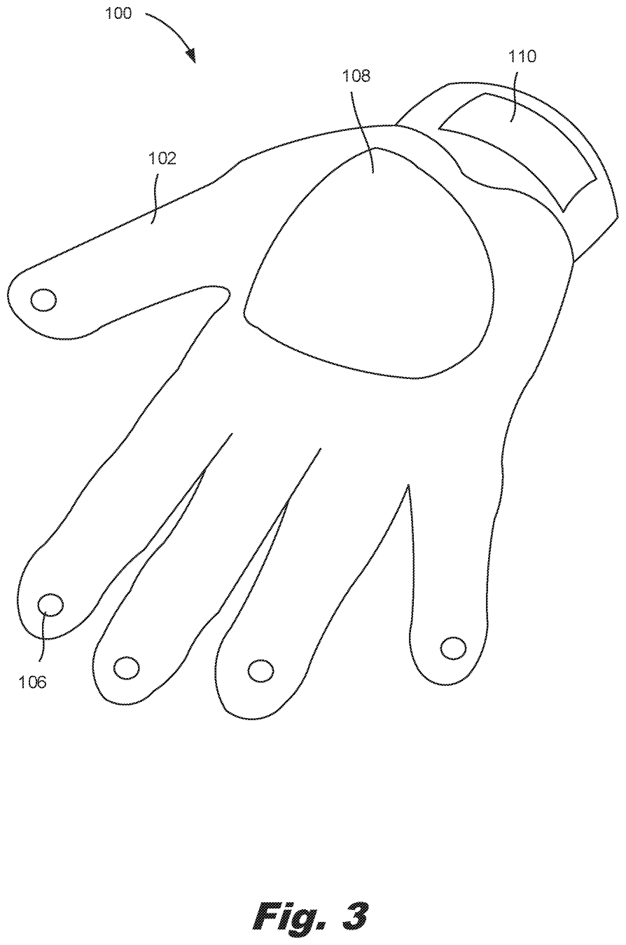

FIG. 3 is a palm view of a glove (102) with a self-contained haptic feedback system (FIG. 1, 104), according to an example of the principles described herein. As described above, the computing input device (100) includes a haptic feedback system (FIG. 1, 104) that includes various components and that is entirely disposed on the glove (102). The inflatable haptic feedback device (108) of the haptic feedback system (FIG. 1, 104) may be disposed over the palm region of the glove (102). In this fashion, the user can receive tactile feedback corresponding to an interaction of the hand with an object in the enhanced reality environment. Also as described above, the inflatable haptic feedback device (108) may match the ergonomics of the hand to more accurately replicate a natural interaction.

The self-contained haptic feedback system (FIG. 1, 104) also includes the control system (110) to generate the electronic signals to control the inflatable haptic feedback device (108), the sensors (106), and additional haptic feedback devices (FIG. 2, 218). The control system (110) may be positioned on a part of the glove (102) that does not see much movement. For example, as depicted in FIG. 2, the control system (110) may be disposed on a wrist portion of the glove (102), which wrist portion is below the wrist joint and therefore does not see much movement. Placing the control system (110) here allows for control to be provided to the self-contained haptic feedback system (FIG. 1, 104) without interfering with the movement of the hand. While FIG. 3 depicts the control system (110) in a particular location on the glove (102), it may be placed at other locations so long as it does not impede user motion.

The self-contained haptic feedback system (FIG. 1, 104) also includes sensors (106) disposed at various locations on the glove (102). For simplicity, a single sensor (106) is indicated with a reference number. As described above, these sensors (106) may be of varying types and can be used at least to alter the operation of the haptic feedback devices and to generate data from which a user hand, and the movement thereof, can be digitized in the enhanced reality environment. While FIG. 3 depicts the sensors (106) as being disposed on the finger tips, the sensors (106) may be placed at other, or additional, locations.

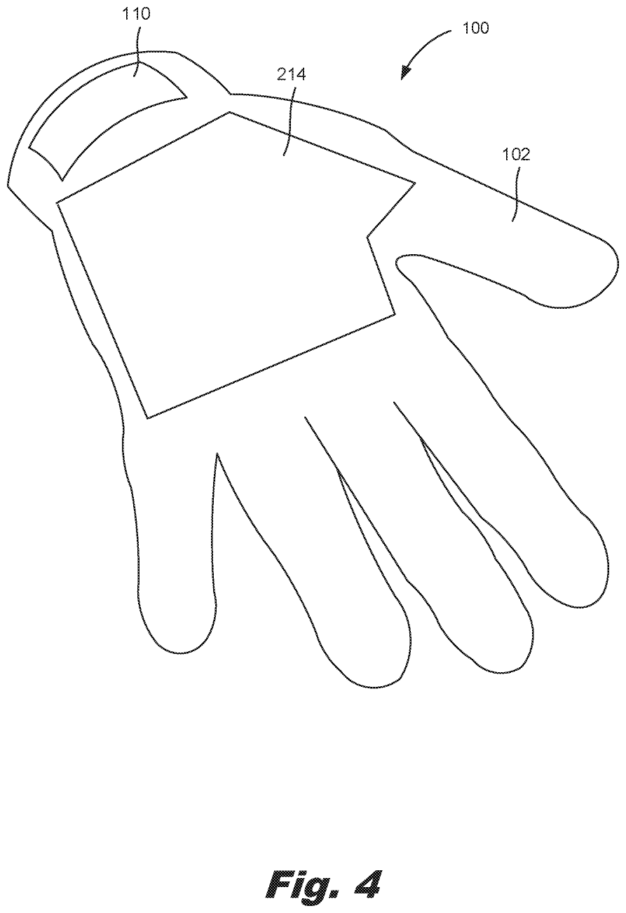

FIG. 4 is a dorsal, or backside view of a glove (102) with a self-contained haptic feedback system (FIG. 1, 104), according to an example of the principles described herein. That is, FIG. 4 depicts a view of the glove (102) disposed over a back, or top, side of the hand and the components of the self-contained haptic feedback system (FIG. 1, 104) disposed on the backside of the glove (102). Specifically, FIG. 4 depicts an alternate location for the control system (110) with its accompanying components. In this example, the control system (110) is still located along the wrist region, just past the wrist joint.

FIG. 4 also depicts the flexible battery (214) that is disposed on a neutral surface. That is, the back part of an individual's hand does not move much, despite the frequent and complete motion of the fingers. While the back of the hand may move to a degree, the flexible battery (214) may be configured such that it can accommodate the range of motion of the top of the hand. Accordingly, the flexible battery (214) may be disposed on a region of the glove (102) that covers the space between the wrist joint and the knuckles of each finger. In so doing, a user can use the haptic feedback glove (102) without being tethered to a power supply, thus enhancing the experience of the user. In other words, the glove (102) is a self-contained system that in addition to providing haptic feedback, also provides the powering of those components on the glove (102) itself.

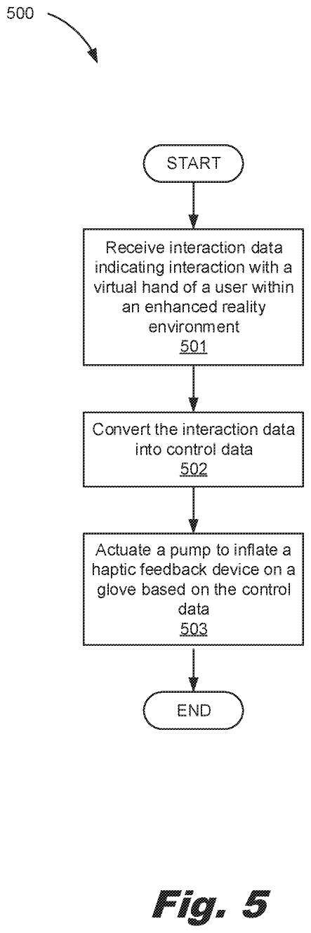

FIG. 5 is a flowchart showing a method (500) of controlling a glove (FIG. 1, 102) with a self-contained haptic feedback system (FIG. 1, 104), according to an example of the principles described herein. According to the method (500), interaction data is received (block 501) from a computing input device (FIG. 1, 100). That is, movements of the hand of a user within the glove (FIG. 1, 102) indicate that the user is interacting with an object, or otherwise moving, within the enhanced reality environment. Sensors (FIG. 1, 106) disposed in, or on, the glove (FIG. 1, 102) detect such movement.

This received data is converted (block 502) into control data. That is, the data indicative of a user interacting with the enhanced reality environment, along with additional control signals are used to operate the inflatable haptic feedback device (FIG. 1, 108) and other haptic feedback devices (FIG. 2, 218). Given different interaction data, the control data may be different. For example, if a user grasps a solid hard object such as a tool handle, then the interaction data may so indicate and the control data will direct a pump (FIG. 2, 212) to operate for a longer period of time to inflate the inflatable haptic feedback device (FIG. 1, 108) to a degree where it replicates the hard tool surface. In another example, if a user touches a soft surface such as a seat cushion, then the interaction data may so indicate and the control data will direct the pump (FIG. 2, 212) to operate for a shorter period of time to inflate the inflatable haptic feedback device (FIG. 1, 108) to a lesser degree such that it replicates the physical touch of a soft seat cushion surface.

Accordingly, the control system (FIG. 1, 110) then operates to actuate (block 503) the pump (FIG. 2, 212) to inflate (or deflate) the inflatable haptic feedback device (FIG. 1, 108) based on this control data. In some examples, the pump (FIG. 2, 212) and the inflatable haptic feedback device (FIG. 1, 108) may be sized such that inflation and deflation occur in less than a second, thus quickly replicating the actions occurring within the enhanced reality environment. Such a system facilitates a more complete immersion of the user in the enhanced reality environment resulting in a more satisfactory user experience.

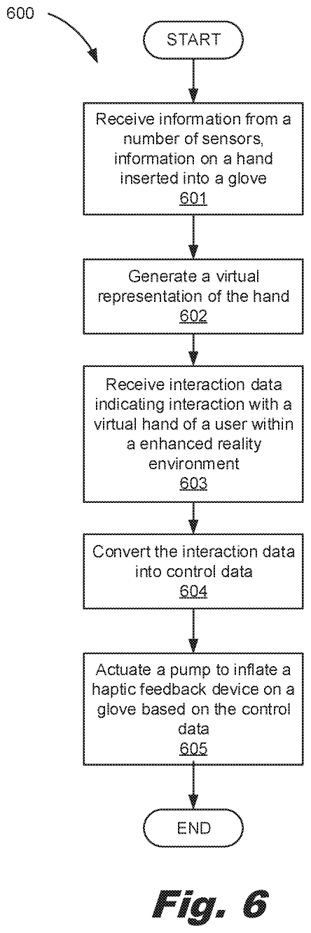

FIG. 6 is a flowchart showing a method (600) of controlling a glove (FIG. 1, 102) with a self-contained haptic feedback system (FIG. 1, 104), according to an example of the principles described herein. According to the method (600), information is received (block 601) from the sensors (FIG. 1, 106) on the glove (FIG. 1, 102). That is, sensors (FIG. 1, 106) disposed at various locations on the glove (FIG. 1, 102) can indicate a size of the hand and the location of different areas of the hand, i.e., the fingers. This data can be mapped to locations within the enhanced reality environment and be used to generate (block 602) a visual representation of the hand in the enhanced reality environment.

According to the method (600) interaction data indicating the user is interacting with the enhanced reality environment is received (block 603) and converted (block 604) into feedback data. This may be performed as described above in connection with FIG. 5. Based on the control data, and other control signals, a pump (FIG. 2, 212) is actuated (block 605) to replicate the interaction. In some examples, the haptic feedback is based on the information describing the hand of the user. For example, with bigger hands the pump (FIG. 2, 212) may actuate (block 605) to a greater extent while the pump (FIG. 2, 212) may be actuated (block 605) to a lesser degree to accommodate smaller representations of hands. While specific reference is made to the interaction of particular sensors (FIG. 1, 106) and the various haptic feedback devices, others may be present as well. For example, heat sensors (FIG. 1, 106) and/or proximity sensors (FIG. 1, 106) may affect the degree to which the pump (FIG. 2, 212) is actuated to inflate the inflatable haptic feedback device (FIG. 1, 108).

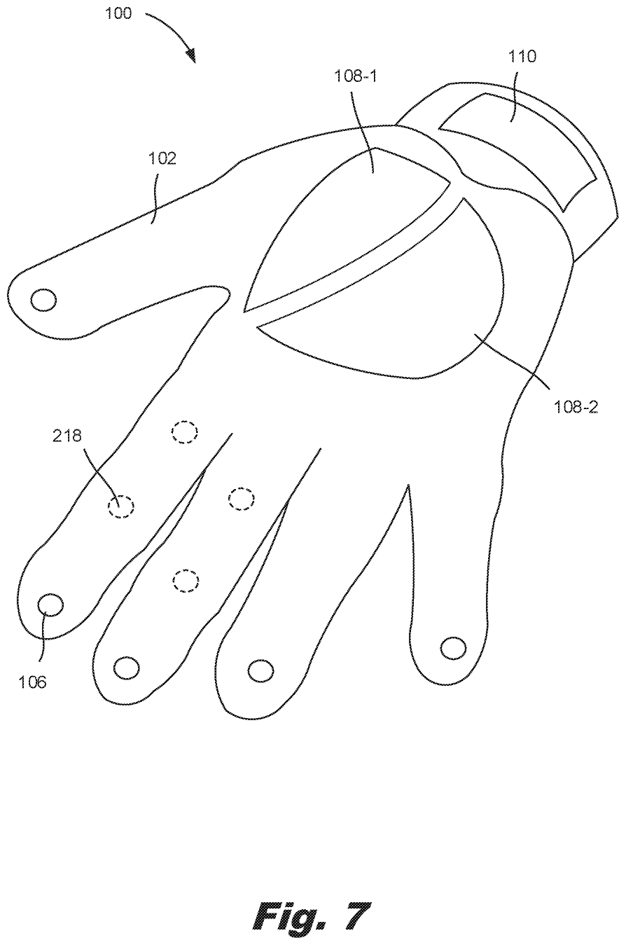

FIG. 7 is a palm view of a glove (102) with a self-contained haptic feedback system (FIG. 1, 104), according to another example of the principles described herein. In the example depicted in FIG. 7, the control system (110) is disposed on a neutral wrist portion of the glove (102) and the sensors (106) are disposed on the finger tips. Again, for simplicity, just one instance of a sensor (106) is indicated with a reference number and a certain number of sensors (106) are depicted at particular locations. However, any number of sensors (106) may be included on the glove (102) at any particular location.

FIG. 7 also depicts the additional haptic feedback devices (218) that are used to provide additional sources of haptic feedback. Again, for simplicity, just one instance of an additional haptic feedback device (218) is indicated with a reference number and the haptic feedback devices (218) are depicted at particular locations. However, any number of haptic feedback devices (218) may be included on the glove (102) at any particular location.

In this example, the self-contained haptic feedback system (FIG. 1, 104) includes an additional inflatable haptic feedback device (108-2) in addition to the first inflatable haptic feedback device (108-1). Using multiple inflatable haptic feedback devices (108) provides for a more fine-tuned haptic interface. That is, more complex interactions can be mapped with the use of multiple haptic interface devices (108). For example, each different inflatable haptic feedback device (108) can be separately controlled and coupled to different pumps (FIG. 2, 212) such that each can be inflated to different volumes. Thus an even richer enhanced experience can be replicated.

In summary, using such a computing input device 1) digitizes a users hand thus making it visible in the enhanced reality environment; 2) provides a user with a sensation of physically holding an object represented in the enhanced reality environment; 3) creates a more immersive enhanced reality environment; and 4) is self-contained to enhanced user mobility. However, the devices disclosed herein may address other matters and deficiencies in a number of technical areas.

What is claimed is:

1. A computing input device comprising:
a glove to be worn by a user; and
a self-contained haptic feedback system disposed on the glove, the self-contained haptic feedback system comprising:
a sensor disposed in the glove to collect information from an inserted hand;
an inflatable haptic feedback device positioned over a palm region of the glove; and
a control system to provide fluidic and electronic control over the inflatable haptic feedback device.

2. The computing input device of claim 1, wherein the control system comprises a pump disposed on the glove to inflate and deflate the inflatable haptic feedback device based on received control data.

3. The computing input device of claim 1, further comprising a flexible battery disposed on a dorsal region of the glove to power the self-contained haptic feedback system.

4. The computing input device of claim 1, wherein the control system is disposed on a wrist region of the glove.

5. The computing input device of claim 1, wherein the inflatable haptic feedback device is inflated to replicate a virtual object in an enhanced reality environment.

6. The computing input device of claim 1, wherein the control system comprises an input/output device to allow data transmission to and from the control system.

7. The computing input device of claim 1, wherein the glove comprises a flexible fabric disposed over the inflatable haptic feedback device.

8. A method comprising:
receiving from a computing input device, interaction data indicating interaction of a virtual hand of a user within an enhanced reality environment;
converting the interaction data into control data to activate an inflatable haptic feedback device, which inflatable haptic feedback device is located in a palm region of a glove; and
actuating a pump disposed on the glove to inflate the inflatable haptic feedback device based on the control data.

9. The method of claim 8, further comprising receiving, from a sensor on the glove, information from an inserted hand and wherein the haptic feedback is provided based on collected information.

10. The method of claim 8, further comprising:
receiving, from a sensor on the glove, information from an inserted hand; and
generating a virtual representation of the inserted hand in an enhanced reality environment.

11. A computing input device comprising:
a glove to be worn by a user;
a self-contained haptic feedback system disposed on the glove, the self-contained haptic feedback system comprising:
a plurality of sensors to collect information from an inserted hand, the plurality of sensors comprising a first set of sensors to generate position data;
an inflatable haptic feedback device positioned over a palm region of the glove;
a pump disposed on the glove to inflate and deflate the inflatable haptic feedback device based on received control data;
a flexible battery disposed on a dorsal region of the glove to power the plurality of sensors, the inflatable haptic feedback device, and the pump;
a control system disposed on the glove to, based on the position data, form a representation of the inserted hand in an enhanced reality environment; and
an additional haptic feedback device disposed on the glove.

12. The computing input device of claim 11, wherein:
the plurality of sensors comprise sensors selected from the group consisting of:
heat sensors;
pressure sensors; and
motion sensors; and
the additional haptic feedback devices comprise devices selected from the group consisting of:
heat feedback devices;
pressure feedback devices; and
vibration feedback devices.

13. The computing input device of claim 11, wherein the additional inflatable haptic feedback device is positioned over the palm region of the glove.

14. The computing input device of claim 11, wherein the flexible battery is charged wirelessly from a power source.

15. The computing input device of claim 11, wherein the flexible battery charged via a wire to a power source.
